(19) United States
(12) Patent Application Publication
(10) Pub. No.: US 2026/0246221 A1
(43) Pub. Date: Aug. 20, 2026

(54) OPTICAL FIBER AND OPTICAL AMPLIFIER

(71) Applicant: NTT, Inc., Tokyo (JP)

(72) Inventors: Kohei OMOTO, Musashino-shi, Tokyo (JP); Yuto SAGAE, Musashino-shi, Tokyo (JP); Taro IWAYA, Musashino-shi, Tokyo (JP); Ryota IMADA, Musashino-shi, Tokyo (JP); Taiji SAKAMOTO, Musashino-shi, Tokyo (JP); Masaki WADA, Musashino-shi, Tokyo (JP); Takayoshi MORI, Musashino-shi, Tokyo (JP); Takashi MATSUI, Musashino-shi, Tokyo (JP); Kazuhide NAKAJIMA, Musashino-shi, Tokyo (JP)

(73) Assignee: NTT, Inc., Tokyo (JP)

(21) Appl. No.: 19/162,063

(22) PCT Filed: Mar. 22, 2023
(86) PCT No.: PCT/JP2023/011126

§ 371 Date: Sep. 4, 2025

(51) Int. Cl. H01S 3/067; G02B 6/02; H01S 3/10

(52) U.S. Cl. CPC H01S 3/06754; G02B 6/02314; H01S 3/10023

(57) ABSTRACT

An optical fiber includes: a core region that is doped with a rare-earth ion; an adjustment region that is constituted by either a hole or a glass rod and is arranged in such a way as to have a central axis parallel to a central axis of the core region; and a cladding region that is arranged in such a way that the core region and the adjustment region are included inside the cladding region, wherein the adjustment region is arranged at a position deviated in an anisotropic manner as viewed from a central axis of the cladding region.

### TECHNICAL FIELD

The present disclosure relates to an optical fiber and an optical amplifier.

### BACKGROUND ART

A rare-earth-doped fiber is known in which a core region is doped with a rare-earth element for the purpose of amplifying signal light that propagates through the core. Here, in a cladding-pumped rare-earth-doped fiber, skew mode propagation through a cladding region is likely to occur, but the skew mode does not contribute to optical amplification, and coupling efficiency (optical amplification efficiency) with signal light decreases.

Non Patent Literatures 1 to 3 discloses a technique of forming a cladding having a non-circular cross-section such as a polygon or a D-shape structure in order to reduce skew mode propagation through the cladding region in a rare-earth-doped fiber in which a core region is doped with a rare-earth element.

Patent Literature 1 discloses a technique of reducing spaces between optical fibers generated when the optical fibers are arranged in a matrix by forming the optical fibers so as to have a square or regular hexagonal cross-section.

### CITATION LIST

### Non Patent Literature

[Non Patent Literature 1] M. H. Muendel, “Optimal inner cladding shapes for double-clad fiber lasers”, Summaries of papers presented at the Conference on Lasers and Electro-Optics (1996).
[Non Patent Literature 2] N. Saidin et al., “Comparison of cladding shaped of Tm/Yb doped fiber laser for optimum lasing efficiency”, 2016 IEEE 6th International Conference on Photonics (2016).
[Non Patent Literature 3] Kensuke Shima et al., “Evolution of Fiber Lasers by Specialty Optical Fibers”, The Review of Laser Engineering, Vol.38, No.11, pp.864-868 (2010).

### Patent Literature

[Patent Literature 1] JP H08-240729 A

### SUMMARY OF THE INVENTION

### Technical Problem

According to the optical fibers disclosed in Non Patent Literatures 1 to 3 and Patent Document 1, since the optical fiber has a non-circular cross-section, the cross-section of the optical fiber changes from the non-circular shape to a rounded shape due to surface tension of glass during a stretching process of heating and stretching a preform having a non-circular cross-section. This poses a problem in that the skew mode cannot be sufficiently reduced and the optical amplification efficiency decreases. Furthermore, there is a problem in that anisotropic distortion occurs in the cross-section of the optical fiber during the stretching process, and birefringence occurs.

The present disclosure has been made in view of the above problems. An object thereof is to provide an optical fiber and an optical amplifier capable of reducing a skew mode and increasing an optical amplification efficiency while suppressing anisotropic distortion in a cross-section of the optical fiber in a stretching process of heating and stretching a preform.

### Solution to Problem

In order to solve the above-described problem, an optical fiber according to an aspect of the present disclosure includes: a core region that is doped with a rare-earth ion; an adjustment region that is constituted by either a hole or a glass rod and is arranged in such a way as to have a central axis parallel to a central axis of the core region; and a cladding region that is arranged in such a way that the core region and the adjustment region are included inside the cladding region. The adjustment region is arranged at a position deviated in an anisotropic manner as viewed from a central axis of the cladding region.

An optical amplifier according to an aspect of the present disclosure includes: the optical fiber described above; a pumping light source that emits pumping light that pumps the rare-earth ion; an optical multiplexer that combines and introduces signal light and the pumping light into one end of the optical fiber; and an optical demultiplexer that separates the signal light from light output from the other end of the optical fiber.

### Advantageous Effects Of Invention

According to the present disclosure, it is possible to reduce a skew mode and increase an optical amplification efficiency while suppressing anisotropic distortion in a cross-section of the optical fiber in a stretching process of heating and stretching a preform.

### BRIEF DESCRIPTION OF DRAWINGS

FIG. 1 is a cross-sectional view illustrating a structure of an optical fiber according to the first embodiment of the present disclosure.

FIG. 2 is a cross-sectional view illustrating a structure of the shape of a preform before drawing used for manufacturing the optical fiber illustrated in FIG. 1.

FIG. 3 is a cross-sectional view illustrating the first example of a structure of an optical fiber according to the second embodiment of the present disclosure.

FIG. 4 is a cross-sectional view illustrating the second example of the structure of the optical fiber according to the second embodiment of the present disclosure.

FIG. 5 is a cross-sectional view illustrating the third example of the structure of the optical fiber according to the second embodiment of the present disclosure.

FIG. 6 is a cross-sectional view illustrating a structure of an optical fiber according to the third embodiment of the present disclosure.

FIG. 7 is a schematic diagram illustrating a configuration of an optical amplifier according to an embodiment of the present disclosure.

### DESCRIPTION OF EMBODIMENTS

Next, embodiments of the present disclosure will be described in detail with reference to the drawings. In the description, the same components are denoted by the same reference signs, and redundant description will be omitted.

### First Embodiment

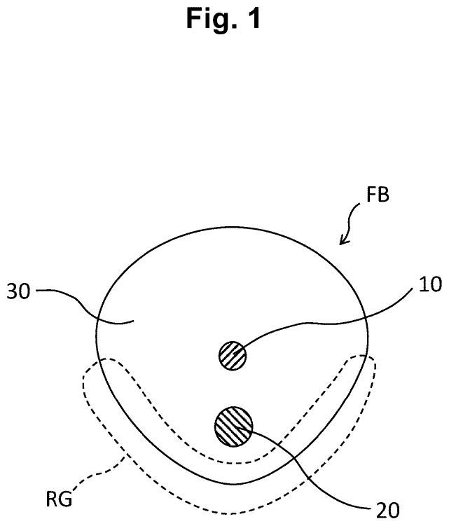

FIG. 1 is a cross-sectional view illustrating a structure of an optical fiber according to the first embodiment of the present disclosure. FIG. 1 illustrates a cross-sectional view in a cross-section orthogonal to the direction in which an optical fiber FB extends (the direction of the central axis). The optical fiber FB includes a core region 10, an adjustment region 20, and a cladding region 30.

The core region 10 is doped with a rare-earth ion. Examples of the rare-earth ion with which the core region 10 of the optical fiber FB is doped include, but are not limited to, Er³⁺, Pr³⁺, Tm³⁺, Yb³⁺, Nd³⁺, and Dy³⁺. The rare-earth ion is selected in accordance with a band of signal light to be amplified. The core region 10 may be doped with a plurality of types of rare-earth ions.

FIG. 1 illustrates an example in which one core region 10 is arranged. Without being limited to this example, the optical fiber FB may include a plurality of the core regions 10.

The adjustment region 20 is constituted by either a hole or a glass rod. The adjustment region 20 is arranged in such a way as to have a central axis parallel to the central axis of the core region 10. Note that the adjustment region 20 is arranged at a position deviated in an anisotropic manner as viewed from the central axis of the cladding region 30.

For example, as illustrated in FIG. 1, the core region 10 is arranged in the vicinity of the central axis of the cladding region 30, and the adjustment region 20 is arranged at a position deviated from the vicinity of the central axis of the cladding region 30 toward the outer peripheral side of the cladding region 30. Furthermore, the adjustment region 20 does not uniformly surround the periphery of the core region 10. The adjustment region 20 is arranged only in a predetermined angular range when viewed from the central axis of the cladding region 30.

The diameter of one adjustment region 20 may be 2 μm or more. This is because, in a case where the diameter of the adjustment region 20 is shorter than the wavelength of light passing through the optical fiber FB, the adjustment region 20 itself scatters the light passing through the optical fiber FB, and scattering loss increases. Furthermore, the diameter of the adjustment region 20 is set to 2 μm or more in consideration of controllability of the adjustment region 20 when the optical fiber FB is formed by a stretching process (drawing) of heating and stretching a preform.

In addition, the adjustment region 20 may have a lower refractive index than the cladding region 30. This suppresses a decrease in coupling efficiency (optical amplification efficiency) with the signal light.

The cladding region 30 is arranged in such a way that the core region 10 and the adjustment region 20 are included inside the cladding region 30. In the example illustrated in FIG. 1, the cladding region 30 has a non-circular cross-section, and, in particular in a region RG, has a shape obtained by distorting a circle.

In order to cause the cladding region 30 to have a shape obtained by distorting a circle in the region RG, in a case where the adjustment region 20 is a hole, drawing is performed while the hole is depressurized. In addition, in a case where the adjustment region 20 is a glass rod, the glass rod may be constituted by material-doped glass having different softening point temperatures or the like.

When a general photonic crystal fiber (PCF) or a hole-assisted optical fiber (HAF) is formed, drawing is performed so that a similar figure to the hole diameter is obtained at the time of creation of the preform. However, when the optical fiber FB is formed, in order to cause the cross-section of the cladding region 30 to have a shape obtained by distorting a circle, it is preferable to avoid, as far as possible, resemblance to the similar figure to the hole diameter at the time of creation of the preform.

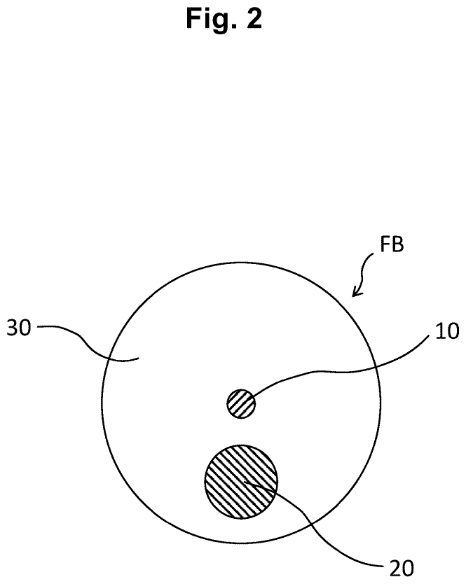

FIG. 2 is a cross-sectional view illustrating a structure of the shape of a preform before drawing used for manufacturing the optical fiber illustrated in FIG. 1. The ratio of the diameter of the adjustment region 20 to the diameter of the cladding region 30 illustrated in FIG. 1 is smaller than the ratio of the diameter of the adjustment region 20 to the diameter of the cladding region 30 illustrated in FIG. 2. That is, in the course of drawing, the reduction ratio of the adjustment region 20 is larger than the reduction ratio of the cladding region 30. As a result, the cross-section of the cladding region 30 has a shape obtained by distorting a circle.

By arranging the adjustment region 20 inside the cladding region 30, it is possible to distort the cross-section of the optical fiber from a circular shape to a non-circular shape in the stretching process of heating and stretching the preform. As a result, skew mode propagation through the cladding region can be reduced, and the optical amplification efficiency can be increased.

### Second Embodiment

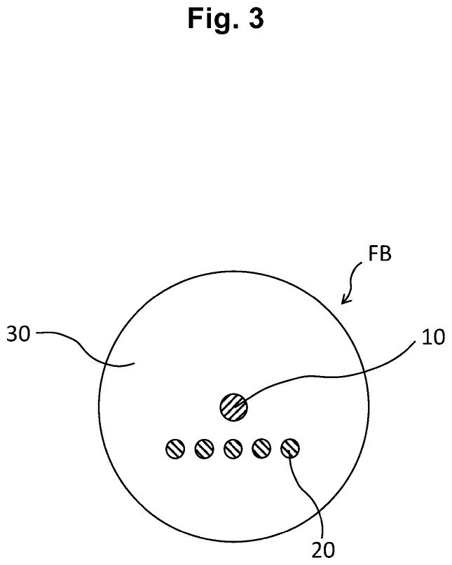

FIG. 3 is a cross-sectional view illustrating the first example of a structure of an optical fiber according to the second embodiment of the present disclosure. FIG. 3 illustrates a state in which an optical fiber FB includes a plurality of adjustment regions 20. In particular, as illustrated in FIG. 3, the plurality of adjustment regions 20 may be linearly arranged in the cross-section of a cladding region 30. In FIG. 3, the plurality of adjustment regions 20 is arranged on a straight line that does not intersect with a core region 10.

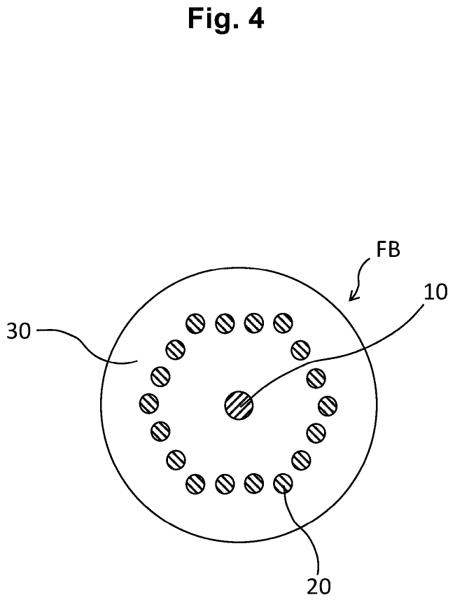

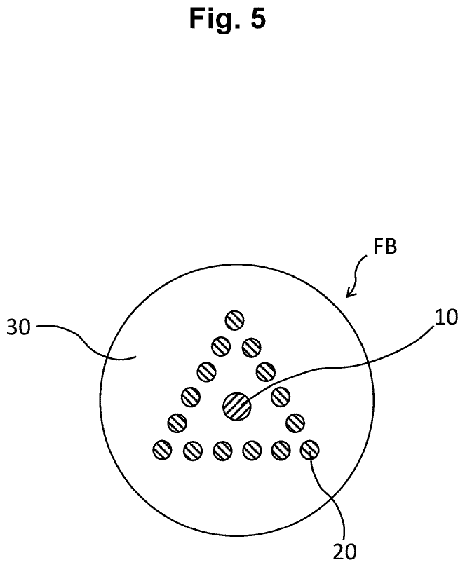

FIG. 4 is a cross-sectional view illustrating the second example of the structure of the optical fiber according to the second embodiment of the present disclosure. FIG. 5 is a cross-sectional view illustrating the third example of the structure of the optical fiber according to the second embodiment of the present disclosure. FIGS. 4 and 5 illustrate a state in which the optical fiber FB includes the plurality of adjustment regions 20. In particular, in the cross-section of the cladding region 30, the plurality of adjustment regions 20 may be arranged on the sides of a polygon that includes the core region 10 inside the polygon.

In FIG. 4, the plurality of adjustment regions 20 is arranged on the sides of a regular hexagon surrounding the core region 10. In FIG. 5, the plurality of adjustment regions 20 is arranged on the sides of an equilateral triangle surrounding the core region 10. Note that the polygon having the sides on which the adjustment regions 20 are arranged is not limited to the examples illustrated in FIGS. 4 and 5.

In FIGS. 3 to 5, in a case where the adjustment regions 20 are holes, uniform pressure can be applied to all the adjustment regions 20 at the time of drawing. Thus, anisotropic distortion in the cross-section of the optical fiber FB can be suppressed, and birefringence can be suppressed.

Furthermore, since the cladding region 30 has a circular outer diameter, it is easy to measure the outer diameter as compared with a cladding having a polygonal cross-sectional shape. Thus, the optical fiber FB illustrated in FIGS. 3 to 5 has an advantage of excellent controllability at the time of manufacturing.

### Third Embodiment

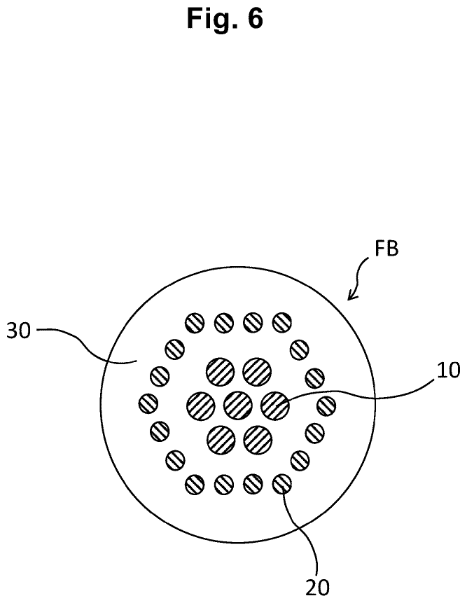

FIG. 6 is a cross-sectional view illustrating a structure of an optical fiber according to the third embodiment of the present disclosure. FIG. 6 illustrates an example in which seven core regions 10 are arranged. In FIG. 6, a plurality of adjustment regions 20 is arranged on the sides of a regular hexagon surrounding the core regions 10. Note that the polygon having the sides on which the adjustment regions 20 are arranged is not limited to the example illustrated in FIG. 6.

The number and arrangement of the core regions 10 included in an optical fiber FB are not limited to the example illustrated in FIG. 6. For example, the number of the core regions 10 included in the optical fiber FB may be any number equal to or larger than two. In the optical fiber FB, the plurality of core regions 10 may be annularly arranged, or may be arranged in a hexagonal close-packed arrangement.

In FIG. 6, in a case where the adjustment regions 20 are holes, uniform pressure can be applied to all the adjustment regions 20 at the time of drawing. Thus, anisotropic distortion in the cross-section of the optical fiber FB can be suppressed, and birefringence can be suppressed.

Furthermore, since a cladding region 30 has a circular outer diameter, it is easy to measure the outer diameter as compared with a cladding having a polygonal cross-sectional shape. Thus, the optical fiber FB illustrated in FIGS. 3 to 5 has an advantage of excellent controllability at the time of manufacturing.

### Configuration of Optical Amplifier

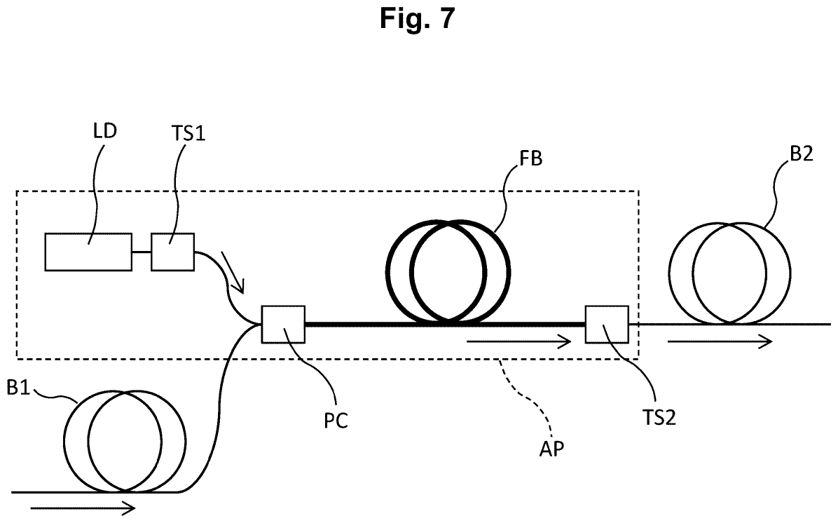

Next, an optical amplifier AP using the optical fiber FB described in the above-described embodiment will be described. FIG. 7 is a schematic diagram illustrating a configuration of an optical amplifier according to an embodiment of the present disclosure. The optical amplifier AP includes a pumping light source LD, an isolator TS1, a pumping light combiner PC, the optical fiber FB described in the above-described embodiment, and an isolator TS2.

The pumping light source LD emits pumping light. The pumping light is light that pumps a rare-earth ion with which the optical fiber FB is doped.

The isolator TS1 introduces the pumping light from the pumping light source LD into the pumping light combiner PC. The isolator TS1 blocks light from the pumping light combiner PC toward the pumping light source LD.

The pumping light combiner PC (optical multiplexer) combines signal light from an input-side optical fiber B1 and the pumping light from the pumping light source LD, and outputs the combined light. The combine light is introduced into one end of the optical fiber FB.

The signal light input to the one end of the optical fiber FB together with the pumping light is amplified while being transmitted through the optical fiber FB, and is emitted from the other end of the optical fiber FB.

The isolator TS2 (optical demultiplexer) separates signal light from the light output from the other end of the optical fiber FB. The separated signal light is introduced into an output-side optical fiber B2. The isolator TS2 blocks the pumping light from the optical fiber FB toward the output-side optical fiber B2.

### Effects of Embodiments

As described above in detail, an optical fiber according to the present embodiment includes: a core region that is doped with a rare-earth ion; an adjustment region that is constituted by either a hole or a glass rod and is arranged in such a way as to have a central axis parallel to a central axis of the core region; and a cladding region that is arranged in such a way that the core region and the adjustment region are included inside the cladding region. The adjustment region is arranged at a position deviated in an anisotropic manner as viewed from a central axis of the cladding region.

This makes it possible to reduce a skew mode and increase an optical amplification efficiency while suppressing anisotropic distortion in a cross-section of the optical fiber in a stretching process of heating and stretching a preform. In particular, by arranging the adjustment region inside the cladding region, it is possible to distort the cross-section of the optical fiber from a circular shape to a non-circular shape in the stretching process of heating and stretching the preform. As a result, skew mode propagation through the cladding region can be reduced, and the optical amplification efficiency can be increased. In addition, anisotropic distortion in the cross-section of the optical fiber is suppressed, and as a result, occurrence of birefringence is suppressed.

In the optical fiber according to the present embodiment, a plurality of adjustment regions may be linearly arranged in the cross-section of the cladding region. As a result, anisotropic distortion in the cross-section of the optical fiber can be suppressed, and birefringence can be suppressed. In particular, uniform pressure can be applied to all the adjustment regions at the time of drawing, and anisotropic distortion can be suppressed. In addition, since the cladding region has a circular outer diameter, it is easy to measure the outer diameter as compared with a cladding having a polygonal cross-sectional shape. This provides an advantage that controllability at the time of manufacturing is excellent.

Furthermore, in the optical fiber according to the present embodiment, a plurality of adjustment regions may be arranged, in the cross-section of the cladding region, on the sides of a polygon that includes the core region inside the polygon. As a result, anisotropic distortion in the cross-section of the optical fiber can be suppressed, and birefringence can be suppressed. In particular, uniform pressure can be applied to all the adjustment regions at the time of drawing, and anisotropic distortion can be suppressed. In addition, since the cladding region has a circular outer diameter, it is easy to measure the outer diameter as compared with a cladding having a polygonal cross-sectional shape. This provides an advantage that controllability at the time of manufacturing is excellent.

Furthermore, it is not necessary to form the preform in a polygonal shape. Also in the stretching process of heating and stretching the preform, it is not necessary to maintain the preform in a polygonal shape. Thus, the accuracy required in the stretching process when manufacturing the optical fiber of the present embodiment is lower than the accuracy required in the stretching process of a cladding having a polygonal cross-sectional shape. Thus, the manufacturing costs can be reduced.

In the optical fiber according to the present embodiment, one adjustment region may have a diameter of 2 μm or more. As a result, it is possible to suppress scattering of light passing through the optical fiber caused by the adjustment region itself, and prevent an increase in scattering loss by providing the adjustment region. Furthermore, it is possible to maintain controllability of the adjustment region in the stretching process of heating and stretching the preform.

Furthermore, in the optical fiber according to the present embodiment, the adjustment region may have a lower refractive index than the cladding region. This suppresses a decrease in coupling efficiency (optical amplification efficiency) with the signal light in the optical fiber having the adjustment region.

In addition, the optical amplifier according to the present embodiment includes: the optical fiber described above; a pumping light source that emits pumping light that pumps the rare-earth ion; an optical multiplexer that combines and introduces signal light and the pumping light into one end of the optical fiber; and an optical demultiplexer that separates the signal light from light output from the other end of the optical fiber. As a result, the signal light input to the one end of the optical fiber together with the pumping light can be amplified with high efficiency.

Although the contents of the present disclosure have been described above according to the embodiments, the present disclosure is not limited to the description thereof, and it is obvious to those skilled in the art that various modifications and improvements can be made. It should not be construed that the present disclosure is limited to the statements and the drawings that constitute a part of the present disclosure. Various alternative embodiments, examples, and operating techniques will be apparent to those skilled in the art from this disclosure.

It is needless to say that the present disclosure also includes various embodiments that are not described herein. Therefore, the technical scope of the present disclosure is defined only by the invention-specifying matters according to the claims appropriate from the above description.

### REFERENCE SIGNS LIST

10 core region
20 adjustment region
30 cladding region
AP optical amplifier
B1 input-side optical fiber
B2 output-side optical fiber
FB optical fiber
LD pumping light source
PC pumping light combiner (optical multiplexer)
TS1, TS2 isolator (optical demultiplexer)

1. An optical fiber comprising:
a core region that is doped with a rare-earth ion;
an adjustment region that is constituted by either a hole or a glass rod and is arranged in such a way as to have a central axis parallel to a central axis of the core region; and
a cladding region that is arranged in such a way that the core region and the adjustment region are included inside the cladding region,
wherein the adjustment region is arranged at a position deviated in an anisotropic manner as viewed from a central axis of the cladding region.

2. The optical fiber according to claim 1, wherein a plurality of the adjustment regions is linearly arranged in a cross-section of the cladding region.

3. The optical fiber according to claim 1, wherein a plurality of the adjustment regions is arranged, in a cross-section of the cladding region, on sides of a polygon that includes the core region inside the polygon.

4. The optical fiber according to claim 1, wherein one adjustment region has a diameter of 2 μm or more.

5. The optical fiber according to claim 1, wherein the adjustment region has a lower refractive index than the cladding region.

6. An optical amplifier comprising:
the optical fiber according to claim 1;
a pumping light source that emits pumping light that pumps the rare-earth ion;
an optical multiplexer that combines and introduces signal light and the pumping light into one end of the optical fiber; and
an optical demultiplexer that separates the signal light from light output from the other end of the optical fiber.
